(19) United States
(12) Patent Application Publication
(10) Pub. No.: US 2009/0302825 A1
(43) Pub. Date: Dec. 10, 2009

(54) CURRENT SOURCE

(75) Inventor: Chung-Hsuan HSIEH, Hsinchu City (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: RAYDIUM SEMICONDUCTOR CORPORATION, Hsinchu (TW)

(21) Appl. No.: 12/255,036

(22) Filed: Oct. 21, 2008

(30) Foreign Application Priority Data
Jun. 4, 2008 (TW) TW97120738

(51) Int. Cl. G05F 3/26

(52) U.S. Cl. 323/315

(57) ABSTRACT

A current source includes a node, a biasing circuit, a loading circuit and a current mirror. The node has a specified voltage. The biasing circuit biases the specified voltage to be a first reference voltage. The loading circuit provides an equivalent resistor across the node and a second reference voltage to generate a reference current. The loading circuit includes a resistor and a metal oxide semiconductor field effect transistor (MOSFET). The resistor has a first temperature coefficient. The transistor operating in a linear region is controlled by a control voltage to turn on and to form a transistor resistor coupled with the resistor in series. The transistor resistor has a second temperature coefficient, wherein a temperature coefficient of the equivalent resistor is relevant to the first and second temperature coefficients. The current mirror receives the reference current and provides a mirrored current of the reference current as the output current.

### CURRENT SOURCE

This application claims the benefit of Taiwan application Serial No. 97120738, filed Jun. 4, 2008, the subject matter of which is incorporated herein by reference.

### BACKGROUND OF THE INVENTION

1. Field of the Invention

The invention relates in general to a current source, and more particularly to a current source for generating a temperature-independent reference current.

2. Description of the Related Art

In the present technology, a current source has existed and been widely applied to various circuit designs. For example, a transistor is biased by way of current source when an analog circuit is designed. In these applications, the current source is requested to provide a stable output current.

Generally, however, most electrical properties of electrical elements tend to vary with ambient temperature or processing techniques. Similarly, circuit elements applied to the current source also tends to be changed due to the variation of the environment temperature and the processing technique. Thus, the current source cannot provide a stable output current when the conditions, such as the processing technique and the environment temperature, are changed. Thus, it is an important subject of the industry to design a current source capable of generating a substantially stable current source without being influenced by the manufacturing process as well as the operating temperature.

### SUMMARY OF THE INVENTION

The present invention is directed to a current source capable of providing a substantially stable output current when the conditions of the environment temperature and the processing technique are changed as compared with the conventional current source.

According to the present invention, a current source used for generating a stable output current is provided. The current source includes a node, a biasing circuit, a loading circuit and a current mirror. The node has a node voltage. The biasing circuit adjusts the node voltage according to the first reference voltage so that the node voltage could be biased to be the same as the first reference voltage through the feedback loop. The loading circuit comprising of a resistor and a first transistor provides an equivalent resistor across the node and a second reference voltage and generates a reference current. The resistor has a first temperature coefficient. The first transistor whose gate is controlled by the first control voltage is biased in linear region and forms a transistor resistor coupled with the resistor in series. The transistor resistor has a second temperature coefficient. The temperature coefficient of the equivalent resistor formed by the resistor and the first transistor is relevant to the first and second temperature coefficients. The current mirror receives the reference current and thus generates the output current by way of mapping.

The invention will become apparent from the following detailed description of the preferred but non-limiting embodiments. The following description is made with reference to the accompanying drawings.

### BRIEF DESCRIPTION OF THE DRAWINGS

FIG. 1 is a block diagram showing a current source according to an embodiment of the invention.

FIG. 2 is a block diagram showing another current source according to the embodiment of the invention.

FIG. 3 is a block diagram showing still another current source according to the embodiment of the invention.

FIG. 4 is a simulated graph showing a resistance value of a resistor R of FIG. 1 with respect to the temperature.

FIG. 5 is a simulated graph showing a resistance value of an equivalent resistor Rmnt of a transistor MNT of FIG. 1 with respect to the temperature.

FIG. 6 is a simulated graph showing a current value of a reference current Iref of FIG. 1 with respect to the temperature.

### DETAILED DESCRIPTION OF THE INVENTION

The current source of this embodiment compensates for the property change of the circuit element, which is caused by the temperature coefficient of the current source and the processing technique, using a serially connected transistor.

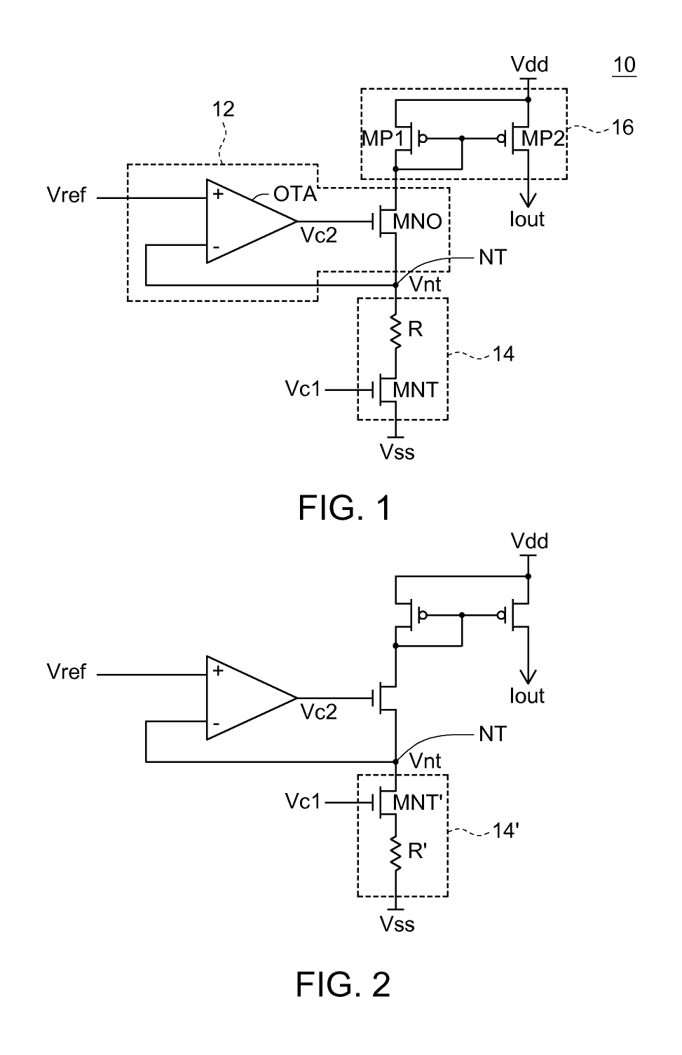

FIG. 1 is a block diagram showing a current source 10 according to an embodiment of the invention. Referring to FIG. 1, the current source 10 for generating a stable output current Iout includes a node NT, a biasing circuit 12, a loading circuit 14, and a current mirror 16. The node NT has a node voltage Vnt.

The biasing circuit 12 biases the node voltage Vnt according to a reference voltage Vref so that the node voltage Vnt is biased to be the reference voltage Vref. For example, the biasing circuit 12 includes an operational amplifier OTA and a transistor MNO, such as an N-type metal oxide semiconductor (NMOS) transistor.

The operational amplifier OTA has a positive input terminal for receiving the reference voltage Vref, a negative input terminal coupled to the node NT to receive the node voltage Vnt, and an output terminal coupled to the gate of the transistor MNO. The drain of the transistor MNO is coupled to the current mirror 16, and the source of the transistor MNO is coupled to the node NT.

The operational amplifier OTA amplifies the difference between the reference voltage Vref and the node voltage Vnt to obtain a control voltage Vc2. The transistor MNO is controlled by the control voltage Vc2 to control the level of the node voltage Vnt and feed the node voltage Vnt back to the negative input terminal of the operational amplifier OTA. Thus, the level of the node voltage Vnt is substantially biased to be the level of the reference voltage Vref via a negative feedback circuit structure of the operational amplifier OTA and the transistor MNO. In this embodiment, the level of the reference voltage Vref is substantially kept unchanged with the change of the ambient temperature of the current source 10.

The loading circuit 14 provides an equivalent resistor R_{EQ} across the node NT and a reference voltage Vss to generate a reference current Iref. For example, the reference voltage Vss is a grounding reference level of the current source 10. The loading circuit 14 includes a resistor R and a transistor MNT coupled with the resistor R in series. Thus, the equivalent resistor R_{EQ} is equal to the sum of the resistance values of the resistor R and an equivalent resistor Rmnt of the transistor MNT, and the reference current Iref satisfies the following equation:

$$Iref = \frac{Vnt - Vss}{{R}_{EQ}} = \frac{Vnt - Vss}{R + Rmnt} \qquad ( 1 )$$

For example, the transistor MNT is an NMOS transistor. The resistor R has a temperature coefficient α, for example. The transistor MNT controlled by a control voltage Vc1 operates in a linear region to form the transistor resistor Rmnt coupled with the resistor R in series. The transistor resistor has a temperature coefficient β. The temperature coefficient of the equivalent resistor is relevant to the temperature coefficients α and β.

The current mirror 16 correspondingly generates the output current Iout according to the reference current Iref, wherein the current value of the output current Iout is relevant to the current value of the reference current Iref. For example, the current mirror 16 outputs the output current Iout substantially equal to the reference current Iref.

Furthermore, when the temperature coefficient α is considered, the resistance value of the resistor R satisfies:

R=R_{E}×(1+α×ΔT) (2)

wherein RE is, for example, the resistance value of the resistor R when the temperature coefficient α is not considered, and ΔT is the temperature difference.

Similarly, when the temperature coefficient β is considered, the resistance value of the transistor resistor Rmnt satisfies:

Rmnt=Rmnt_{E}×(1+β×ΔT) (3)

wherein RmntE is, for example, the resistance value of the transistor resistor Rmnt when the temperature coefficient β is not considered.

According to Equations (2) and (3), it is obtained that the equivalent resistor R_{EQ} satisfies:

$$\begin{matrix}{R}_{EQ} = {R}_{E} \times ( 1 + α \times Δ T ) + {Rmnt}_{E} \times ( 1 + β \times Δ T ) \\ = {R}_{E} \times ( 1 + \frac{{Rmnt}_{E}}{{R}_{E}} ) + {R}_{E} \times ( α + β \times \frac{{Rmnt}_{E}}{{R}_{E}} ) \times Δ T\end{matrix} \qquad ( 4 )$$

It is assumed that the resistor R has a negative temperature coefficient (i.e., the temperature coefficient α is a real number smaller than zero), that the transistor resistor Rmnt has a positive temperature coefficient (i.e., the temperature coefficient β is a real number greater than zero), and that the temperature coefficients α and β satisfy:

$$α + β \times \frac{Rmnt}{R} = 0 \qquad ( 5 )$$

Thus, the resistance value of the equivalent resistor R_{EQ} is substantially kept unchanged with the variation of the temperature. In other words, the temperature coefficient of the equivalent resistor R_{EQ} is substantially equal to zero.

Because the temperature coefficient of the equivalent resistor R_{EQ} is substantially equal to zero and the reference voltages Vref and Vss are not changed with the change of the ambient temperature of the current source 10, the reference current Iref is also substantially kept unchanged with the change of the ambient temperature of the current source 10 according to Equation (1).

In this embodiment, the gates of the transistors MNT and MNO respectively receive the control voltages Vc1 and Vc2. Preferably, the control voltage Vc1 and the control voltage Vc2 have substantially the same level. When the transistors MNT and MNO are controlled by the same control voltage, the current source 10 of this embodiment may further provide the substantially stable output current when different processing techniques are used.

More specifically, when another processing technique is adopted to manufacture the current source 10, the threshold voltages (Vth) of the transistors MNT and MNO have the variations δ. Thus, the threshold voltage values of the transistors MNT and MNO satisfy:

Vth′=Vth+δ (6)

wherein Vth′ is the threshold voltage of the transistors MNT and MNO when the another processing technique is being adopted.

Because the transistor MNO operates in the saturation region and the node voltage Vnt is biased to be the reference voltage Vref, the control voltage Vc2 is finely tuned, by the negative feedback circuit, to be:

$$\begin{matrix}Vc 2 = Vref + {Vth}^{′} = Vref + ( Vth + δ ) & ( 7 ) \\ {I}_{D} = \frac{μ {C}_{OX}}{2} {( \frac{W}{L} )}_{MNO} \times {( Vc {2}^{′} - Vref - {Vth}^{′} )}^{2} & ( 7 A ) \\ \begin{matrix}Vc {2}^{′} - {Vth}^{′} = Vref + \sqrt{\frac{{I}_{D}}{\frac{μ {C}_{OX}}{2} {( \frac{W}{L} )}_{MNO}}} \\ = Vref + Vod \\ = Vc 2 - Vth\end{matrix} & ( 7 B )\end{matrix}$$

Assume the control voltages Vc1 and Vc2 have the same level. Thus, the difference between the gate-source voltage of the transistor MNT and the threshold voltage thereof satisfies:

VGS−Vth′=[Vc1′−Vss]−[Vth′]=[Vref+Vod+Vth+δ]−[Vth+δ]=Vref+Vod (8)

According to Equation (8), it is obtained that, when the threshold voltage of the transistor MNT is increased by the variation δ, the gate-drain voltage VGS of the transistor MNT is also correspondingly increased by the variation δ so that the difference between the gate-drain voltage VGS of the transistor MNT and the threshold voltage thereof is still held equal to the reference voltage Vref plus an over driving (OD) voltage Vod of the transistor MNO.

Consequently, even if another processing technique is adopted to cause the threshold voltages of the transistors MNT and MNO to have the variations δ, the difference between the gate-drain voltage VGS of the transistor MNT and the threshold voltage thereof is still held constant so that the reference current Iref still has the constant value.

In one example, the current mirror 16 includes transistors MP1 and MP2, which are P-type metal oxide semiconductor (PMOS) transistors, for example. The source of the transistor MP1 receives a reference voltage Vdd, and the drain and the gate of the transistor MP1 are coupled to the drain of the transistor MNO. The source of the transistor MP2 receives the reference voltage Vdd, the gate of the transistor MP2 is coupled to the gate of the transistor MP1, and the source of the transistor MP2 provides the output current Iout. For example, the reference voltage Vdd is the highest voltage of the current source 10.

For example, the transistors MP1 and MP2 respectively serve as the current host circuit and the current mapping circuit of the current mirror 16 for respectively receiving the reference current Iref and providing a mirrored current of the reference current Iref as the output current Iout for outputting.

In this embodiment, although the illustrated loading circuit 14 has the circuit structure shown in FIG. 1, the loading circuit 14 of this embodiment is not particularly restricted to the circuit structure shown in FIG. 1. For example, the coupling positions of the resistor R and the transistor MNT may also be exchanged, as shown in FIG. 2. When the loading circuit 14′ has the circuit structure shown in FIG. 2, the loading circuit 14′ of the embodiment may also equivalently provide the equivalent resistor R_{EQ}′ having the temperature coefficient substantially equal to 0.

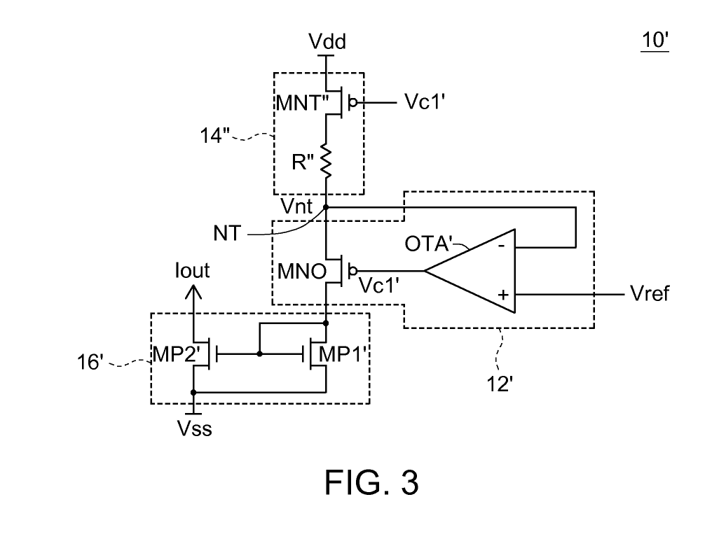

In this embodiment, although the illustrated transistors MNT and MNO are NMOS transistors, the transistors MNT and MNO of this embodiment are not particularly restricted to the NMOS transistors. In another example, as shown in FIG. 3, the transistors MNO′ and MNT′ are PMOS transistors, and the transistors MP1′ and MP2′ of the current source 16′ are NMOS transistors.

In this illustrated embodiment, although the temperature coefficient β of the transistor MNT substantially satisfies Equation (5) so that the temperature coefficient of the equivalent resistor R_{EQ} of the loading circuit 14 is substantially equal to zero, the temperature coefficients α and β of the transistor MNT and the resistor R of this embodiment are not restricted to the satisfaction of Equation (5). In other conditions, the temperature coefficients α and β may also satisfy:

$$\begin{matrix}α + β \times \frac{Rmnt}{R} > 0 & ( 9 ) \\ α + β \times \frac{Rmnt}{R} < 0 & ( 10 )\end{matrix}$$

Thus, the equivalent resistor R_{EQ} of the loading circuit 14 of this embodiment correspondingly has the temperature coefficient greater than zero or smaller than zero.

The current source of this embodiment compensates for the property change of the circuit element, which is caused by the temperature coefficient of the current source and the processing technique, using the serially connected transistor. Thus, compared with the conventional current source, the current source of this embodiment can advantageously provide the substantially stable output current when the environment temperature is changed.

In addition, in some circuit implementations, the current source may further perform the compensation via the design of the biasing circuit when the condition of the processing technique is changed. Thus, compared with the conventional current source, the current source of this embodiment may further advantageously provide the substantially stable output current when the processing technique is changed.

### Simulated Result

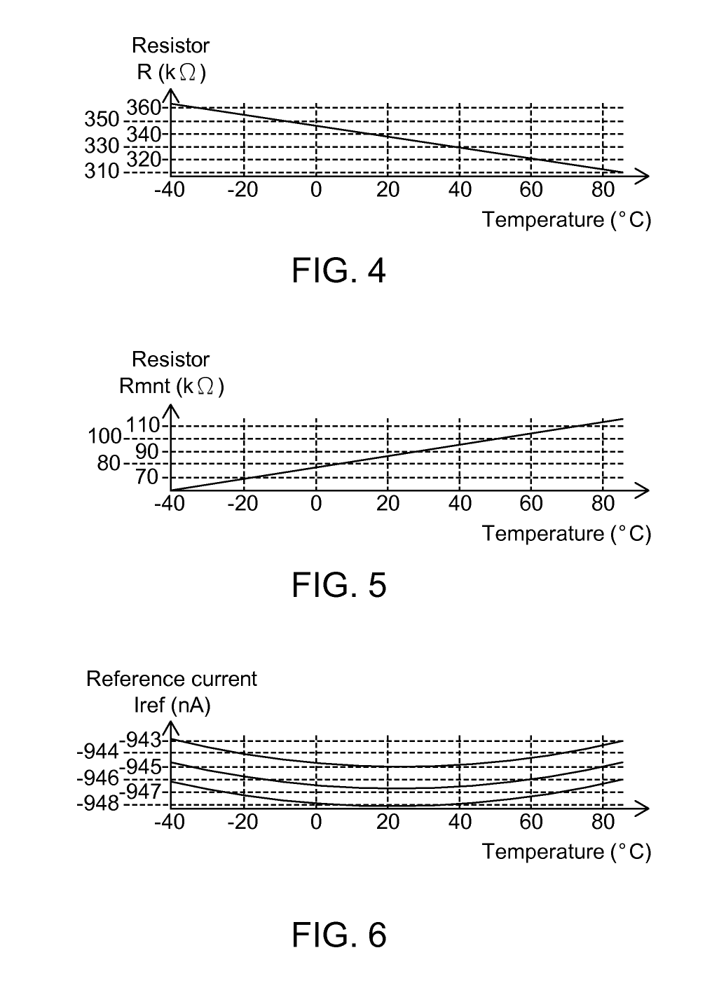

FIG. 4 is a simulated graph showing the resistance value of the resistor R of FIG. 1 with respect to the temperature. As shown in FIG. 4, in the zone wherein the temperature ranges from −40° C. to 80° C., the resistance value of the resistor R is decreased from 360 KΩ to 310KΩ. In other words, the temperature coefficient α of the resistor R is about −0.00133/°C. FIG. 5 is a simulated graph showing the resistance value of the equivalent resistor Rmnt of the transistor MNT of FIG. 1 with respect to the temperature. In order to compensate for the temperature coefficient α of the resistor R, the provided transistor MNT and the resistor R are connected in series. In the zone wherein the temperature ranges from −40° C. to 80° C., the resistance value of the transistor resistor Rmnt is increased from 60KΩ to 110KΩ.

FIG. 6 is a simulated graph showing the current value of the reference current Iref of FIG. 1 with respect to the temperature. In the zone wherein the temperature ranges from −40° C. to 80° C., the current value of the reference current Iref ranges between 943 nano-amperes (nA) and 948 nA. Thus, the current source 10 of this embodiment can generate the reference current Iref, which is substantially kept unchanged with the change of the ambient temperature of the current source 10, and the fluctuation variation of the reference current Iref is smaller than 1% of the reference current Iref.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A current source for generating an output current, the current source comprising:
a node having a node voltage;
a biasing circuit for biasing the node voltage according to a first reference voltage so that the node voltage is biased to be the first reference voltage;
a loading circuit for providing an equivalent resistor across the node and a second reference voltage and generating a reference current, the loading circuit comprising:
a resistor having a first temperature coefficient; and
a first transistor controlled by a first control voltage to turn on, wherein the transistor operates in a linear region and forms a transistor resistor coupled with the resistor in series, the transistor resistor has a second temperature coefficient, and a temperature coefficient of the equivalent resistor is relevant to the first and second temperature coefficients; and
a current mirror for receiving the reference current and providing a mirrored current of the reference current as the output current.

2. The current source according to claim 1, wherein the biasing circuit comprises:
an operational amplifier having a positive input terminal for receiving the first reference voltage, a negative input terminal coupled to the node, and an output terminal for generating a second control voltage; and
a second transistor for feeding the node voltage back to the negative input terminal of the operational amplifier in response to the first control voltage, wherein the second transistor is controlled by the first control voltage to turn on and thus to provide the reference current to the current mirror.

3. The current source according to claim 2, wherein the first and second control voltages have substantially the same level.

4. The current source according to claim 1, wherein the first transistor has a source for receiving the second reference voltage and a drain coupled to one terminal of the resistor, and the other terminal of the resistor is coupled to the node.

5. The current source according to claim 1, wherein the first transistor has a drain coupled to the node and a source coupled to one terminal of the resistor, and the other terminal of the resistor receives the second reference voltage.

6. The current source according to claim 1, wherein the current mirror comprises:
a current host circuit for receiving the reference current; and
a current mapping circuit for providing the mirrored current of the reference current as the output current.

7. The current source according to claim 1, wherein a temperature coefficient of the equivalent resistor is relevant to the first temperature coefficient and the temperature coefficient.
